(19) United States
(12) Patent Application Publication
(10) Pub. No.: US 2025/0182041 A1
(43) Pub. Date: Jun. 5, 2025

(54) DISTRIBUTION SYSTEM AND METHOD FOR DISTRIBUTING A PLURALITY OF CARRIERS

(71) Applicant: Roche Diagnostics Operations, Inc., Indianapolis, IN (US)

(72) Inventors: Edwin Oosterbroek, Cham (CH); Nicolas Seungoon Sillitoe, Allenwinden (CH)

(21) Appl. No.: 19/004,137

(22) Filed: Dec. 27, 2024

Related U.S. Application Data
(63) Continuation of application No. PCT/EP2023/067433, filed on Jun. 27, 2023.

(30) Foreign Application Priority Data
Jun. 28, 2022 (EP) 22181626.7

(51) Int. Cl. G06Q 10/0835; G05D 1/644; G05D 1/698; G05D 101/00; G05D 105/28

(52) U.S. Cl. CPC G06Q 10/08355; G05D 1/644; G05D 1/6987; G05D 2101/22; G05D 2105/28

(57) ABSTRACT

A distribution system for distributing carriers has a transport plane with logical positions. The carriers transport objects and a drive system moves the carriers on the transport plane between the logical positions. A controller moves the carriers on a planned route from a start position to a final destination on the transport plane. The planned route is made up of partial routes, and a routing system calculates routing plans for carriers on the transport plane by modeling the transport plane with graphs of nodes. The routing plans are calculated considering moving time periods and waiting time periods. The waiting time periods are assigned based on a reservation of logical positions of the partial routes of other carriers. Thus, if a carrier experiences a time delay during execution of a move, the routing system shifts the experienced time delay to an upcoming waiting time period of a carrier.

### RELATED APPLICATIONS

This application is a continuation of International Application Serial No. PCT/EP2023/067433, filed Jun. 27, 2023, which claims priority to European Patent Application Serial No. 22 181 626.7, filed Jun. 28, 2022, the entire disclosures of both of which are hereby incorporated herein by reference.

### BACKGROUND

The present disclosure relates to a distribution system and a method for distributing a plurality of carriers using the distribution system. The system and method of the present disclosure, as an example, may be used for controlling movement of carriers transporting sample containers, in particular sample tubes, filled with biological fluids to be analyzed or reagents, and/or cassettes filled with reagents, specimen slides, tissue material, waste, disposables like pipette tips or tube caps, and/or empty tubes for aliquoting, specifically in the field of diagnostic laboratories. The system and method can also be used for other applications requiring controlling the movement of carriers on a transport plane, such as carriers transporting payloads such as goods, wares of a warehouse, products to be manufactured in a manufacturing site or other objects.

In the field of diagnostic laboratories, generally, a plurality of samples, for example, liquid samples, have to be handled automatically. The automatic handling of samples may comprise automatically transporting sample containers, specifically sample containers comprising the samples to be handled, via carriers in the diagnostic laboratory by means of one or more distribution systems.

For example, EP 3 095 739 A1 describes a method of operating a laboratory sample distribution system. The laboratory sample distribution system comprises: a number of sample container carriers, wherein the sample container carriers are adapted to carry one or more sample containers, wherein the sample containers comprise samples to be analyzed by means of a number of laboratory stations; a transport plane, wherein the transport plane is adapted to support the sample container carriers, wherein the transport plane comprises a number of transfer locations, wherein the transfer locations are assigned to corresponding laboratory stations; and drive means, wherein the drive means are adapted to move the sample container carriers on the transport plane. The method comprises the steps: during an initialization of the laboratory sample distribution system, pre-calculating routes depending on the transfer locations, and after the initialization of the laboratory sample distribution system, controlling the drive means such that the sample container carriers move along the pre-calculated routes.

EP 3 537 159 A1 discloses a method of operating a laboratory sample distribution system. The laboratory sample distribution system comprises: a plurality of sample container carriers, wherein the sample container carriers are adapted to carry a laboratory sample container; a transport plane, wherein the transport plane is adapted to support the sample container carriers; and a plurality of drive elements, wherein the drive elements are adapted to move the sample container carriers on the transport plane. The method comprises the steps: a) planning a movement path for one of the sample container carriers from a start to a goal on the transport plane, wherein the transport plane is logically modeled by a plurality of nodes, wherein the nodes are free for at least one time-window or reserved for at least one-time window, wherein the planning comprises analyzing the reachability out of a free time-window of one of the nodes to free time-windows of at least one next node and at least one at least over-next node, such that a planned movement of the one sample container carrier is nonstop from the one node over the next node to the at least one over-next node, and reserving the planned movement path comprising a sequence of time-windows of nodes; and b) executing by controlling at least one of the drive elements, such that the one sample container carrier moves along the reserved movement path on the transport plane.

U.S. Pat. No. 10,006,927 B2 discloses a method of operating a laboratory automation system. The laboratory automation system comprises a plurality of laboratory stations and a plurality of sample container carriers. The sample container carriers carry one or more sample containers. The sample containers comprise samples to be analyzed by the laboratory stations. The system also comprises a transport plane. The transport plane supports the sample container carriers. The system also comprises a drive. The drive moves the sample container carriers on the transport plane. The method comprises, during an initialization of the laboratory automation system, logically reserving at least one buffer area on the transport plane and, after the initialization of the laboratory automation system, buffering in the at least one buffer area sample container carriers carrying sample containers comprising samples waiting for a result of an analysis. Depending on the result of the analysis, the samples are further processed.

U.S. Publication No. 2018/0348244 A1 describes a method of operating a laboratory sample distribution system. The system comprises sample container carriers comprising a magnetically active device and configured to carry a sample container, interconnected transport plane modules configured to support carriers, and electromagnetic actuators arranged in rows and columns below each transport plane module and configured to move a carrier on top of the transport plane modules by applying a magnetic force to the carrier. The method comprises assigning transport plane modules to a route category. At least two traffic lanes are formed on the route categorized transport plane module. The carriers are moved within each traffic lane in a transport direction. The transport directions are opposite to each other. The method also comprises assigning another transport plane module to a waypoint category. A change from one transport direction to the opposite transport direction is possible on the waypoint categorized transport plane module.

WO 2021/228733 A1 discloses a distribution system comprising a transport plane for distributing objects and carriers for transporting the objects. A drive system moves the carriers on the transport plane. A control system of the distribution system is configured to control the carriers to move on a planned route from a start position to a final destination position on the transport plane. The control system comprises a routing system configured to calculate the planned route for at least two carriers on the transport plane by modelling the transport plane with nodes and graphs and using a windowed hierarchical cooperative informed search algorithm. The routing system is configured to determine reserved and free time windows for each node. The routing system is configured to assign an individual reservation length to each carrier for the next move on free time windows and assigns an infinite reservation time to the node of a logical position.

Despite the advantages achieved by known methods and devices, several technical challenges remain. Specifically, problems due to unexpected time delays may still occur. For example, time delay in the movement of carriers may have to be considered while guaranteeing safe passage of the carriers in the distribution system towards a safe point. Generally, a time delay of one carrier may affect a movement plan of other carriers in the distribution system. Thus, it may be of great importance to avoid that time delays in routing one carrier affect the routing of one or more other carriers in the distribution system, specifically without the need for newly planning moves for one or more other carriers. Creating a completely new plan for affected carriers is a rather computation-intensive task and should be avoided accordingly. Simply shifting all time plans of affected carriers with a time equal to the initial delay, would mean that all affected carriers will be strongly delayed, which reduces the performance of the system. Solving the time delay may be additionally complicated by the fact that a transport system may include a control mechanism for avoiding too many simultaneous moves per area, in order to control the maximum power draw per transport area.

### SUMMARY

This disclosure teaches methods and devices which at least partially address above-mentioned technical challenges. Specifically, a distribution system and a method for distributing a plurality of carriers is disclosed which allows for preventing problems arising from unexpected time delays.

As used in the following, the terms “have,” “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B,” “A comprises B” and “A includes B” may both refer to a situation in which, besides B, no other element is present in A (i.e., a situation in which A solely and exclusively consists of B) and to a situation in which, besides B, one or more further elements are present in entity A, such as element C, elements C and D or even further elements.

Further, it shall be noted that the terms “at least one,” “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, notwithstanding the fact that the respective feature or element may be present once or more than once. By way of non-limiting example, the terms “transport plane,” “drive system,” and “control system,” to name just a few, should be interpreted wherever they appear in this disclosure and claims to mean “at least one” or “one or more” regardless of whether they are introduced with the expressions “at least one” or “one or more.” All other terms used herein should be similarly interpreted unless it is made explicit that a singular interpretation is intended.

Further, as used in the following, the terms “preferably,” “more preferably,” “particularly,” “more particularly,” “specifically,” “more specifically” or similar terms are used in conjunction with optional features, without restricting alternative possibilities. Thus, features introduced by these terms are optional features and are not intended to restrict the scope of the claims in any way. The disclosure may, as the skilled person will recognize, be performed by using alternative features. Similarly, features introduced by “in an embodiment of the disclosure” or similar expressions are intended to be optional features, without any restriction regarding alternative embodiments of the disclosure, without any restrictions regarding the scope of the disclosure and without any restriction regarding the possibility of combining the features introduced in such way with other optional or non-optional features of the disclosure.

In a first aspect of the present disclosure, a distribution system is disclosed. The distribution system comprises:
at least one transport plane comprising logical positions;
a plurality of carriers for transporting objects;
at least one drive system for moving the carriers on the transport plane between the logical positions; and
at least one control system configured for controlling the carriers to move on a planned route from a start position to a final destination position on the transport plane, wherein the planned route comprises partial routes, wherein the control system comprises at least one routing system configured for calculating routing plans for carriers on the transport plane by modeling the transport plane with graph of nodes, wherein the routing system is configured for calculating the routing plans considering moving time periods and waiting time periods, wherein the routing system is configured for assigning waiting time periods for carriers depending on a reservation of logical positions of the partial routes of other carriers, wherein, if a carrier experiences a time delay during execution of a move, the routing system is configured for shifting the experienced time delay to at least one upcoming waiting time period of a carrier.

The term “system” as used herein is a broad term and is to be given its ordinary and customary meaning to a person of ordinary skill in the art and is not to be limited to a special or customized meaning. The term specifically may refer, without limitation, to an arbitrary set of interacting or interdependent components forming a whole. Specifically, the components may interact with each other in order to fulfill at least one common function. The at least two components may be handled independently or may be coupled or connectable.

The term “distribution system” as used herein is a broad term and is to be given its ordinary and customary meaning to a person of ordinary skill in the art and is not to be limited to a special or customized meaning. The term specifically may refer, without limitation, to a system configured for distributing carriers from an initial position to a target destination. The distribution system may be an element of a laboratory automation system allowing to distribute carriers to a target destination within the laboratory automation system. Distribution systems may be used in laboratory automation systems comprising a number of laboratory stations, for example, pre-analytical, analytical and/or post-analytical stations. Distribution systems are generally known by the skilled person, e.g., from EP 3 095 739 A1 or WO2012/158541.

The term “object” as used herein is a broad term and is to be given its ordinary and customary meaning to a person of ordinary skill in the art and is not to be limited to a special or customized meaning. The term specifically may refer, without limitation, to arbitrary payload. The object may be at least one sample container, such as laboratory diagnostic containers or vessels.

The term “carrier” as used herein is a broad term and is to be given its ordinary and customary meaning to a person of ordinary skill in the art and is not to be limited to a special or customized meaning. The term specifically may refer, without limitation, to a support structure configured for supporting and transporting a payload. The carrier may be provided with appropriate holding means to support, and if required, to secure payload in a needed manner and orientation. The carrier can be self-propelling or can be propelled by and moved on a transport plane.

The term “transport plane” as used herein is a broad term and is to be given its ordinary and customary meaning to a person of ordinary skill in the art and is not to be limited to a special or customized meaning. The term specifically may refer, without limitation, to any kind of two dimensional plane, bed, layer, platform or flat base configured for transporting carriers. The transport plane may be configured such that carriers are positionable onto the transport plane, in particular on a surface of the transport plane, such that the carriers are movable in at least two dimensions along the transport plane. For instance, the transport plane may be a sliding surface mounted in on or more of a diagnostics laboratory, instrument, a floor or surface of a laboratory or manufacturing site or inside a manufacturing or storage hall. The transport plane may be installed vertically or horizontally including slopes. Also curved transport planes may be possible.

The transport plane may be configured for providing movement of the carrier by contact. The transport plane may constitute a coordinate system, wherein movements of the carriers may happen in x and y directions on the transport plane. The transport plane may be configured such that a carrier can contact the surface of the transport plane such that friction can be used to drive and control movements of the carrier. The transport plane may be configured for contactless movement of the carrier. The transport plane may be configured such that a carrier can move contactless, e.g., by air or magnetic levitation providing a small gap between carrier and the surface. For a third dimension, either the transport plane may be formed correspondingly with corresponding limitations in upward and downward slope, or some kind of levitation mechanism may be installed such as magnetic levitation or air cushion technique with the corresponding limitations in reachable height without losing control. For vertical transportation in the third dimension also elevator or paternoster mechanisms can be installed.

The term “drive system” as used herein is a broad term and is to be given its ordinary and customary meaning to a person of ordinary skill in the art and is not to be limited to a special or customized meaning. The term specifically may refer, without limitation, to a system configured for moving the carriers on the transport plane. The drive system can be implemented in the carriers itself, e.g., wheels connected to an electric motor with connected battery and electronics. Another possibility are linear motors. Also possible are passive carriers. For instance, a magnetic device is fixed in the carrier and a magnetic force provided by magnetically active and drivable elements, such as electro-magnetic coils, enforce the carriers to move by generated electro-magnetic fields. The coils can be installed under, above, besides or in the transport plane. For instance, an arrangement of magnetic coils underneath the transport plane is described, e.g., in EP 2 566 787 or WO 2013/098202.

The term “logical position” is a broad term and is to be given its ordinary and customary meaning to a person of ordinary skill in the art and is not to be limited to a special or customized meaning. The term specifically may refer, without limitation, to an arbitrary location of the transport plane being adapted to support a carrier. A presentation of the transport plane may be a graph with logical positions or logical positions and allowed connections between them. The transport plane may be mathematically mapped to a graph of logical positions or a graph of logical positions and allowed connections between them. Routing, for example, finding of routing plans, of the carriers on the logical positions may be performed using the graph. The drive system is configured for moving the carriers on the transport plane between the logical positions. The moving between the logical positions may comprise following the logical positions.

Logical positions may be defined on the transport plane by hardware requirements and/or by software. The logical position may be an imaginary position in the routing algorithm and/or a position on the real transport system. For example, a logical position may be defined on the transport plane as a position at which the carrier can stop, start and/or change direction. In systems such as described in EP2 566 787 or WO 2013/098202, the drive system may define these logical positions by its hardware limitations. Logical positions may be defined above an electro-magnetic coil. At these positions, it may be possible to stop the carrier and to change its direction with the next move. The logical positions may be defined as wanted or required to form a useful set of crossing points, junctions, start and stop positions. The logical position may be a discrete position where the carrier can stop. In particular, the logical position may be defined by at least one physical entity of the drive system, such as an electromagnetic coil or a crossing of possible ways such as rails.

Each of the logical positions may be configured for being occupied by only one carrier. Thus, two carriers cannot share one logical position. The distribution system may be configured for moving a plurality of carriers on the transport plane via respective calculated partial routes, wherein the respective route may lead from a first logical position to a second logical position, i.e., the end position of the respective partial route.

A logical position can be any position reachable by the carriers or any position where the carriers can change direction, be parked or can be identified by an identification or registration system. Identification and registration systems can be a camera system or optical sensors and scanners identifying any optical signature on the carriers or object such as its size, its type, or a bar code. Alternatively or in addition, a RFID-reader system reading a unique RFID of the carrier or object on the carrier or sensors inside the transport plane can be used to identify logical positions and to localize the carriers. A further option can be high precision GPS, in particular enhanced with Wi-Fi and/or GSM signals.

The term “control system” (also referred to herein as “controller”) as used herein is a broad term and is to be given its ordinary and customary meaning to a person of ordinary skill in the art and is not to be limited to a special or customized meaning. The term specifically may refer, without limitation, to an arbitrary system configured for performing the named operations, preferably by using at least one data processing device and, more preferably, by using at least one processor and/or at least one application-specific integrated circuit. Thus, as an example, the at least one control system may comprise at least one data processing device having a software code stored thereon comprising a number of computer commands. The control system may provide one or more hardware elements for performing one or more of the named operations and/or may provide one or more processors with software running thereon for performing one or more of the named operations. The control system may comprise one or more programmable devices such as one or more computers, application-specific integrated circuits (ASICs), Digital Signal Processors (DSPs), or Field Programmable Gate Arrays (FPGAs) which are configured to perform steps b) and c). Additionally or alternatively, however, the control system may also fully or partially be embodied by hardware.

The control system may comprise the routing system for calculating the routing plans and at least one executing unit for execution of movements of the carriers according to the planned routing plans. The control system may control the drive system to distribute carriers from the initial position to the target destination. Specifically, controlling may comprise controlling the distribution of carriers and, further, monitoring the distribution of carriers and, if necessary, adapting or changing the distribution of carriers.

The term “route” as used herein is a broad term and is to be given its ordinary and customary meaning to a person of ordinary skill in the art and is not to be limited to a special or customized meaning. The term specifically may refer, without limitation, to a set of partial routes from a start position to a final destination position. The term “routing plan” as used herein is a broad term and is to be given its ordinary and customary meaning to a person of ordinary skill in the art and is not to be limited to a special or customized meaning. The term specifically may refer, without limitation, to a plan comprising at least one route and assigned logical positions in time as planned by the routing system. The terms “planned routing plan” and “plan” are used as synonyms herein. The route may be divided into one or more partial routes to intermediate destinations. The start position may be a logical position where the carrier stands on the transport plane when the algorithm starts calculating the routing plan. The final destination position may be a logical position on the transport plane where the carrier needs to go to. Final destination positions are logical positions on the transport plane which have in particular a special functionality, e.g., where a sample tube, a part of the sample, or a consumable is handed over from or to the transport plane to or from, e.g., an analyzer or pre- or post-analytical system or storage system. For a manufacturing site, a final destination position may be in particular a logical position corresponding to a machine station performing some manufacturing process on a semi-finished good. A start position for one carrier can also be in particular a final destination position for another carrier or more in particular for the same carrier.

The term “routing system” (also referred to herein as “router”) as used herein is a broad term and is to be given its ordinary and customary meaning to a person of ordinary skill in the art and is not to be limited to a special or customized meaning. The term specifically may refer, without limitation, to an arbitrary system configured for calculating routing plans for moving the carriers on the transport plane. The routing system may comprise at least one data processing device. The routing system may be configured for using at least one algorithm, in particular denoted as routing algorithm. A routing algorithm may be an algorithm calculating a routing plan for each carrier on the transport plane from a start position to an intermediate destination position towards a final destination position. The routing algorithm may calculate several straight moves for each route starting with the current position of the carrier on a logical position as a starting position to an intermediate destination position. The routing plan may comprise all moves or only the next few moves to carry out until a second final destination is reached.

The calculating of the routing plans may comprise determining shortest paths for the carriers across the transport plane from the start position to the final destination position. The routing algorithm may be used for determining shortest paths for the carriers across the transport plane. The algorithm may be selected from the group consisting of: a A*-algorithm; a Windowed Hierarchical Cooperative A*-algorithm (WHCA*); a D*-algorithm; a Dijkstra's algorithm.

For example, a WHCA* search algorithm may be used for calculating the routing plans. With respect to WHCA* algorithm reference is made, e.g., to Silver, D., 2005, “Cooperative pathfinding,” Young, R. M., and Laird, J. E., eds., AIIDE, 117-122. AAA I Press. The WHCA* search algorithm may be an informed search algorithm such as A* or D* searching algorithm. For each carrier with a final destination the search algorithm calculates a routing plan from the start position to an intermediate destination position on nodes within the cooperative search window of time length T towards their respective final destination position. The search is cooperative because the route can only pass on free time windows of logical positions. For the logical positions with free time windows needed the required duration of the free time window will change from “free” to “reserved” for the required time slot of the respective logical positions. So the free time window will be split into a reserved time window and one or two further free time windows. The search is hence cooperative for the cooperative time window T by respecting the reserved time windows for other carriers of the logical positions. The WHCA* algorithm may be designed for planning a routing plan for each carrier individually, wherein cooperation may be obtained using a reservation table. The routing system may be configured for reserving the planned partial route for the carrier until the carriers reaches its intermediate or final destination. This means that no other carrier can use the reserved route while the respective carrier is moving. If the logical position is set to “reserved” for a finite duration, the position is not available for the other carriers during the finite duration and will be available again for a move once the temporary reservation is over.

As outlined above, the routing system may be configured to calculate routing plans for all carriers on the transport plane by modeling the transport plane with a graph of nodes. To do so, the routing system may be configured to determine reserved and free time windows for each node. To calculate routing plans for the carriers, the routing system may use a windowed hierarchical cooperative informed search algorithm with cooperative time window T. In particular the cooperative informed search algorithm is a Dijkstra-, Bellman-Ford- or more in particular an A*-algorithm. T is typically in the range of 1 to 300 secs, in particular from 1 to 60 secs, more particular 10 secs. The routing system may be configured to assign an individual reservation length as a number of nodes for the next move on logical positions with free time windows for each carrier, so that the carriers start and stop individually. The executing unit may be configured for executing the planned routing plans for transporting the carriers from their respective start position to their respective final position.

The calculating of the routing plans may comprise planning the routes. The routing system may be configured for determining optimal routes for the carriers across the transport plane. The optimal route may be determined in terms of at least one optimization target such as one or more of time, resource consumption, cost, wear balancing, good overall transport performance. Since the routing algorithm used may be cooperative, the routing system may take care that all carriers find their way through in a net efficient way, if necessary, sacrificing the shortest times to the final destinations of individual carriers. The optimal route for a respective carrier may be a route selected from a plurality of possible routes which minimizes the optimization target, e.g., the time needed for reaching its final destination position.

The routing system may be configured for calculating the routing plans for carriers on the transport plane by modeling the transport plane with graphs of nodes. The term “node” as used herein is a broad term and is to be given its ordinary and customary meaning to a person of ordinary skill in the art and is not to be limited to a special or customized meaning. The term specifically may refer, without limitation, to a mathematical presentation of a logical position. The term “graph” as used herein is a broad term and is to be given its ordinary and customary meaning to a person of ordinary skill in the art and is not to be limited to a special or customized meaning. The term specifically may refer, without limitation, to a construct of nodes and possible connections between them.

The executing unit may be configured for executing moves of the carrier considering the planned routing plan. The term “move” may refer to an “action” and may not include the waiting time before the next move will take place. A move may be defined as one movement of a carrier in a straight line, starting from one logical position and stopping at a second, different logical position. A move can comprise a displacement of a carrier of one or multiple logical positions. The move length may be a number of logical positions for each move. Specifically, a move may be a straight-line displacement without stopping the carrier in between. Moving from a first final destination to a second final destination may be carried out in one or more moves with intermediate destinations. The intermediate destination may also be a logical position. Each move has a start and a stop on a logical position. The stop of a last move of a route is either an intermediate destination or a final destination.

The distribution system may comprise a position determination system configured for determining positions of the carriers on the transport plane. The position determination system may send at least one position update message to the control system. The update message may trigger releasing of reserved logical positions which were already passed by the carrier on its current movement. The update message may inform the control system about delayed carriers.

The routing system is configured for calculating the routing plans considering moving time periods and waiting time periods. The term “moving time period” as used herein is a broad term and is to be given its ordinary and customary meaning to a person of ordinary skill in the art and is not to be limited to a special or customized meaning. The term specifically may refer, without limitation, to a time span during which the carrier is estimated to move. The control system may be configured for controlling the drive system such that the carriers on the transport plane move along the partial routes during the moving time period. The term “waiting time period” as used herein is a broad term and is to be given its ordinary and customary meaning to a person of ordinary skill in the art and is not to be limited to a special or customized meaning. The term specifically may refer, without limitation, to a time span during which the carrier is considered to wait on a logical position. The routing system is configured for assigning waiting time periods for carriers depending on a reservation of logical positions of the partial routes of other carriers. For example, the routing system may assign a waiting time period to a carrier, as long as required nodes for the next partial route are reserved for at least one other carrier. The control system may be configured for controlling the drive system such that the carriers wait on a logical position during the waiting time period.

Calculating of routing plans may comprise assigning logical positions in time to carriers. As a consequence, some carriers have to wait until positions will be free again. As long as a next move cannot be planned, because another carrier needs it for its move, a carrier has to wait. This waiting time can be used to “absorb” at least a part of the delayed time. The term “assigning waiting time periods” as used herein is a broad term and is to be given its ordinary and customary meaning to a person of ordinary skill in the art and is not to be limited to a special or customized meaning. The term specifically may refer, without limitation, to planning of routing plans with waiting time periods. The assigning of waiting time periods may be a consequence of planning the times at which the carriers can move, depending on when positions are released by other carriers and can be reserved for moving. The routing system may be configured for calculating the waiting time and assigns it to the carrier by assigning to the carrier the routing plan with waiting times for the next move.

The routing system may assign the reservation of nodes for the finite duration estimating the time a move will last. However, the time a move lasts may be stochastic such that variations from the estimated time may occur. This may result in that carriers may be late with respect to the planned time for the move. Thus, the original plan is failed. The carrier experiences a time delay during execution of a move or several moves. Thus, the reservation for the late carrier may need to be adapted, specifically extended. However, in known approaches the extension of the reservation for the late carrier would influence and/or cross the reservations for other carriers. The present disclosure proposes that the routing system is configured for extending the reservation for the late carrier without shifting or recalculating all plans, e.g., specifically without shifting or recalculating plans of carriers that are not affected. The presented disclosure proposes resolving the delay by using waiting times to compensate for the lost times. If a carrier experiences a time delay during execution of a move, the routing system is configured for shifting the experienced time delay to at least one upcoming waiting time period of a carrier. The carrier whose waiting time period is used may be any carrier, e.g., the delayed carrier that first experienced the delay or another affected carrier. The term “shifting” as used herein is a broad term and is to be given its ordinary and customary meaning to a person of ordinary skill in the art and is not to be limited to a special or customized meaning. The term specifically may refer, without limitation, to transferring the time delay to the waiting time period. The shifting may comprise changing and/or adapting at least one upcoming waiting time period depending on the time delay. The routing system may be configured for compensating the time delay by shortening the at least one upcoming waiting time period of at least one of the carriers depending on the time delay. The term “upcoming waiting time period” as used herein is a broad term and is to be given its ordinary and customary meaning to a person of ordinary skill in the art and is not to be limited to a special or customized meaning. The term specifically may refer, without limitation, to at least one waiting time period subsequent to the delay. The routing system may be configured for compensating the time delay by shortening the next, also denoted as first, upcoming waiting time period of a carrier, e.g., of the delayed carrier, e.g., by the amount of the time delay. However, if the time delay is longer than the upcoming waiting time period, the time delay cannot be fully compensated by said upcoming waiting time period. Thus, the routing system may be configured for compensating the time delay at least partially by shortening the upcoming waiting time period. In case of a residual time delay, i.e., if the time delay cannot be fully compensated by a first upcoming waiting time period, the routing system may be configured for at least partially shifting the time delay to at least second upcoming waiting time period, e.g., of at least one affected carrier. The routing system may be configured for shifting a non-compensated part of the time delay to the at least one second upcoming waiting time period. The first upcoming waiting time period may be followed in time by the second upcoming waiting time period. If the time delay still cannot be fully compensated by the next waiting time of a carrier, its subsequent waiting time may be used to compensate for the remaining delay, and so on until the delay is completely resolved.

For example, one carrier of a plurality of carriers may be delayed in time. Thus, the original plan is failed. The delay may occur at a first moving time period. The routing system may be configured for compensating the time delay by shortening the upcoming waiting time period. In most cases where only occasionally a short delay occurs, the upcoming waiting time period may already be long enough to be used for compensation. Hence, a solution can be quickly found without affecting many carriers and without computation-intensive re-planning. If the time delay cannot be fully compensated for the upcoming waiting time period, e.g., in case the upcoming waiting time period is too short, all waiting time of the upcoming waiting time period may be consumed and the subsequent upcoming waiting time may be used partially or completely as well, and so on. Hence, the method is recursively executed into the planning future until all delays have been compensated for.

A maximal number of simultaneous moves may be fixed for the whole transport plane or be defined per area. The moves allowed to be performed simultaneously may form a so called simultaneous moves group. For example, maximum of eight carriers may be allowed to move simultaneously per transport module or software-defined area. The number of maximum allowed simultaneous moves can also be related to the number of logical positions in that area. For instance, the maximum allowed simultaneous moves in an area, e.g., can be in the range of 1% to 70% or 5% to 50% or 10% to 30% or 15% to 25% of the number of available logical positions in the area. This may limit the maximum power draw peaks for that area, such that less or smaller power supplies can be used or to protect electronic circuitry against fast aging or damage.

The term “transport module” as used herein is a broad term and is to be given its ordinary and customary meaning to a person of ordinary skill in the art and is not to be limited to a special or customized meaning. The term specifically may refer, without limitation, to separated constructional units and/or sub-units of the transport plane comprising at least one logical position. The transport module may comprise a plurality of logical positions. The transport plane may be a modular transport plane formed by interconnected transport modules. The transport modules may be interconnected such that the carriers may move from each of the transport modules directly or indirectly to each of the other modules. The interconnected transport modules may form a continuous transport plane, which may also be denoted as transport surface. Below each transport module, a number of the electro-magnetic actuators can be stationary arranged in rows and columns. The electromagnetic actuators can be configured to move a carrier on top of the transport modules along a row of the rows or along a column of the columns by applying a magnetic move force to the carrier.

Planned routing plans of carriers may depend on each other, for example, as carriers have to wait for other carriers to release their reserved positions, e.g., if carriers cross each other's paths. If the execution of a move of a carrier is delayed this delay may not only affect the delayed carrier but other carriers, too. A delayed move execution can, for example, be a carrier that arrives at a later time than planned at the last position of its move. Accordingly the duration for this move took longer than planned. The routing system may be configured for determining if the delay of the carrier affects at least one further carrier. The further carrier may be different from the carrier experiencing the time delay. The routing system may be configured for shifting the time delay to at least one waiting time of the at least one further affected carrier.

The routing system may be configured for keeping the calculated route but tries to use the waiting times of affected carriers to resolve the delay. The routing system may be configured for recursively resolving the delay of carriers which are directly and/or indirectly affected by the delay of the carrier. The term “directly affected” carrier as used herein is a broad term and is to be given its ordinary and customary meaning to a person of ordinary skill in the art and is not to be limited to a special or customized meaning. The term specifically may refer, without limitation, to a carrier whose next or subsequent move(s) is influenced by the delay of the originally delayed carrier. The term “indirectly affected” carrier as used herein is a broad term and is to be given its ordinary and customary meaning to a person of ordinary skill in the art and is not to be limited to a special or customized meaning. The term specifically may refer, without limitation, to a carrier whose next or subsequent move(s) is influenced by an extension of at least one reservations of a directly affected carrier and/or a preceding indirectly affected carrier. The term “recursively resolving” as used herein is a broad term and is to be given its ordinary and customary meaning to a person of ordinary skill in the art and is not to be limited to a special or customized meaning. The term specifically may refer, without limitation, to a process of resolving the delay(s) by shifting time(s). Not the routes are changed but only the times.

The waiting times of the affected carriers may be used to resolve the plan due to the delay of one carrier. The delay of the carrier may be solved by using the waiting times of affected moves of the affected carriers. In addition, thereby eventually affected carriers' plans, also denoted as indirectly affected carriers, may be replanned by only changing their move and waiting times. The routing system may be configured for resolving the consequences of the delay of the carrier by using the waiting times of all directly and, if necessary, of indirectly affected carriers. Thus, replanning may be possible without having to re-compute the full routing plan. The control system may be configured to delay, in case no solution can be found to resolve the consequences of the delayed move by using the waiting times, one or more moves of the directly or indirectly affected carriers.

For example, the routing system may be configured for calculating routing plans such that every carrier has a defined number of planned moves, with possible waiting times in between. If a carrier's current move is ongoing past its reservation time, it takes longer than planned. In this case, the carrier's current move's reservations (of logical positions and transport module simultaneous moves) may be extended. The control system, e.g., the routing system, may be configured for checking, before extending the reservation time, if the extension would create an illegal condition, e.g., overlapping logical position reservations and/or excessive number of transport module simultaneous moves. The control system, e.g., the routing system, may be configured for shifting this other carrier's conflicting move's reservations (Logical positions, transport module simultaneous moves) by a minimum amount, if the extension would create an illegal situation. Delaying this other carrier's move's reservations may then affect other carriers' moves, including the original carrier which is late. The control system, e.g., the routing system, may be further configured for delaying, when a carrier's current move is late and its reservations need to be extended, this carrier's later moves, too. This may be required in case the delay cannot be fully absorbed into the waiting time before the next move. The control system, e.g., the routing system, may be configured for recursively shifting moves' reservations, such as in reverse order from the future backwards. The recursion may determine how much delay must be passed onto later moves until no more delay needs to be passed (all absorbed into the waiting times), then those moves' reservations are shifted in reverse order, from the future backwards.

By using the at least one upcoming waiting time period for compensating for the time delay, a problem might happen that the maximum simultaneous moves constraint is violated as moving times are shifted out of the original time window of the original simultaneous moves group. The original simultaneous moves group may comprise the moves originally planned to be performed simultaneously, i.e., according to the original plans of the routing system without delays. Thus, in case only a maximum number of simultaneous moves is allowed, this rule may be violated if no measures are taken. The routing system may be configured for adapting originally planned routing plans of the carriers that would violate the constraint of maximal number of simultaneous moves. The plans for the affected additional carriers, that would violate the maximum simultaneous moves constraint, may be shifted as well and similar to the plans of the delayed carrier(s). Their waiting times may be used to try to compensate for the delays.

In a second aspect, a method for distributing a plurality of carriers using a distribution system according to the present disclosure is disclosed. The method comprises using the distribution system as described above, such as according to one or more of the embodiments given above, or as given in further detail below.

The method comprises moving the plurality of carriers on the at least one transport plane of the distribution system between the logical positions by using the at least one drive system. The method comprises controlling the carriers to move on a planned route from the start position to the final destination position on the transport plane by using the control system. The planned route comprises partial routes. The method comprises calculating the routing plans for carriers on the transport plane by modeling the transport plane with graphs of nodes by using the routing system, wherein the calculated routing plans comprise moving time periods and waiting time periods. The calculating comprises assigning waiting time periods for carriers depending on a reservation of logical positions of the partial routes of other carriers. The calculating comprises, if a carrier experiences a time delay during execution of a move, shifting the experienced time delay to at least one upcoming waiting time period of a carrier.

The method steps may be performed in the given order or may be performed in a different order. Further, one or more additional method steps may be present which are not listed. Further, one, more than one or even all of the method steps may be performed repeatedly.

For details, options and definitions, reference may be made to the distribution system described above.

The method may further comprise determining if the delay of the carrier affects at least one further carrier and shifting the time delay to at least one waiting time of the at least one further affected carrier. The further carrier may be different from the carrier experiencing the time delay. The method further may comprise recursively resolving, e.g., by adjusting and/or adapting, the routing plans of carriers which are directly and/or indirectly affected by the delay of the carrier.

The method may comprise compensating the time delay at least partially by shortening the at least one upcoming waiting time period of a carrier depending on the time delay. In case of a residual time delay, the method may comprise at least partially shifting the residual time delay to at least one second upcoming waiting time period, e.g., of at least one affected carrier. The first upcoming waiting time period may be followed in time by the second upcoming waiting time period.

The method may comprise calculating routing plans, in particular moving times, considering a constraint of a maximal number of simultaneous moves per transport plane or per area of the transport plane, wherein the moves allowed to be performed simultaneously form a simultaneous moves group. The total transport surface can be divided into one or multiple areas and the allowed maximum number of simultaneous moves may be different per area. Originally planned routing plans of the carriers that would violate the constraint of maximal number of simultaneous moves may be adapted.

The method may be computer-implemented. The term “computer implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present disclosure. Specifically, each of the method steps is performed by the computer and/or computer network. The method may be performed completely automatically, specifically without user interaction.

The method and the system according to the present disclosure may provide a large number of advantages over known methods and devices of similar kind. Specifically, by using the method for distributing a plurality of carriers and the distribution system, it may be possible to deal with time delays during movement of the carriers in the distributions system while guaranteeing safe passage to a safe point. Further, the time delay of one carrier, which may affect the routing plan of other carriers, may be handled efficiently. Specifically, the method for distributing a plurality of carriers and the distribution system may allow avoiding that time delay in routing one carrier does not affect the routing of all other carriers in the distribution system. Thus, there may be no need for re-planning the moves for all carriers if a time delay in a move of one carrier occurs. Additionally, it may be possible to comply with the maximum simultaneous moves constraint when accounting for planning time delays from the previous moves.

Further disclosed and proposed herein is a computer program including computer-executable instructions for performing the method according to the present disclosure in one or more of the embodiments enclosed herein when the program is executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps as indicated above may be performed by using a computer or a computer network, preferably by using a computer program.

Further disclosed and proposed herein is a computer program product having program code means, in order to perform the method according to the present disclosure in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the disclosure, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

Summarizing and without excluding further possible embodiments, the following embodiments may be envisaged:

A distribution system comprising
at least one transport plane comprising logical positions;
a plurality of carriers for transporting objects;
at least one drive system for moving the carriers on the transport plane between the logical positions; and
at least one control system configured for controlling the carriers to move on a planned route from a start position to a final destination position on the transport plane, wherein the planned route comprises partial routes, wherein the control system comprises at least one routing system configured for calculating routing plans for carriers on the transport plane by modeling the transport plane with graph of nodes, wherein the routing system is configured for calculating the routing plans considering moving time periods and waiting time periods, wherein the routing system is configured for assigning waiting time periods for carriers depending on a reservation of logical positions of the partial routes of other carriers, wherein, if a carrier experiences a time delay during execution of a move, the routing system is configured for shifting the experienced time delay to at least one upcoming waiting time period of a carrier.

The distribution system according to the preceding embodiment, the routing system is configured for compensating the time delay at least partially by shortening the at least one upcoming waiting time period of a carrier depending on the time delay.

The distribution system according to the preceding embodiment, wherein, in case of a residual time delay, the routing system is configured for at least partially shifting the residual time delay to at least one second upcoming waiting time period, e.g., of at least one affected carrier.

The distribution system according to the preceding embodiment, wherein the first upcoming waiting time period is followed in time by the second upcoming waiting time period.

The distribution system according to any one of the preceding embodiments, wherein the routing system is configured for calculating routing plans considering a constraint of a maximal number of simultaneous moves per transport plane or per area of the transport plane, wherein the moves allowed to be performed simultaneously form a simultaneous moves group, wherein the total transport surface is divided into one or multiple areas and an allowed maximum number of simultaneous moves is different per area.

The distribution system according to the preceding embodiment, wherein the routing system is configured for adapting originally planned routing plans of the carriers that would violate the constraint of maximal number of simultaneous moves.

The distribution system according to any one of the preceding embodiments, wherein the control system comprises at least one executing unit configured for executing the routing plans for transporting the carriers from their respective start position to their respective final position.

The distribution system according to any one of the preceding embodiments, the routing system is configured for using a cooperative path finding algorithm for calculating the routing plans, specifically a Windowed Hierarchical Cooperative A*-algorithm (WHCA*).

A method for distributing a plurality of carriers using a distribution system according to any one of the preceding embodiments, wherein the method comprises moving the plurality of carriers on the at least one transport plane of the distribution system between the logical positions by using the at least one drive system, wherein the method comprises controlling the carriers to move on a planned route from the start position to the final destination position on the transport plane by using the control system, wherein the planned route comprises partial routes, wherein the method comprises calculating routing plans for carriers on the transport plane by modeling the transport plane with graphs of nodes by using the routing system, wherein the calculated routing plans comprise moving time periods and waiting time periods, wherein the calculating comprises assigning waiting time periods for carriers depending on a reservation of logical positions of the partial routes of other carriers, wherein the calculating comprises, if a carrier experiences a time delay during execution of a move, shifting the experienced time delay to at least one upcoming waiting time period of a carrier.

The method according to the preceding embodiment, wherein the method further comprises determining if the delay of the carrier affects at least one further carrier and shifting the time delay to at least one waiting time of the at least one further affected carrier.

The method according to any one of the preceding embodiments referring to a method, wherein the method further comprises recursively resolving the routing plans of carriers which are directly and/or indirectly affected by the delay of the carrier.

The method according to any one of the preceding embodiments referring to a method, wherein the method comprises compensating the time delay at least partially by shortening the at least one upcoming waiting time period of a carrier depending on the time delay.

The method according to the preceding embodiment, wherein, in case of a residual time delay, the method comprises at least partially shifting the residual time delay to at least one second upcoming waiting time period, e.g., of at least one affected carrier.

The method according to the preceding embodiment, wherein the first upcoming waiting time period is followed in time by the second upcoming waiting time period.

The method according to any one of the preceding method embodiments, wherein the method comprises calculating routing plans considering a constraint of a maximal number of simultaneous moves per transport plane or per area of the transport plane, wherein the moves allowed to be performed simultaneously form a simultaneous moves group, wherein the total transport surface is divided into one or multiple areas and an allowed maximum number of simultaneous moves is different per area.

The method according to the preceding embodiment, wherein originally planned routing plans of the carriers that would violate the constraint of maximal number of simultaneous moves are adapted.

The method according to anyone of the preceding method embodiments, wherein the method is computer-implemented.

A computer program comprising instructions which, when the program is executed by the distribution system according to any one of the preceding embodiments referring to a distribution system, cause the distribution system to perform the method according to any one of the preceding embodiments referring to a method.

A computer-readable storage medium comprising instructions which, when the program is executed by the distribution system according to any one of the preceding embodiments referring to a distribution system, cause the distribution system to perform the method according to any one of the preceding embodiments referring to a method.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the disclosure is not restricted by the preferred embodiments. The embodiments are schematically depicted in the Figures. Therein, identical reference numbers in these Figures refer to identical or functionally comparable elements.

FIG. 1 shows an embodiment of a distribution system in perspective view;

FIGS. 2, 3 and 4 show examples of routings plans;

FIG. 5 shows a flow chart of an embodiment of a method for distributing a plurality of carriers; and

FIGS. 6A, 6B, 6C, 6D, 7A, 7B, 7C and 7D show dependency of plans of carriers, consequences of delays and resolving this.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

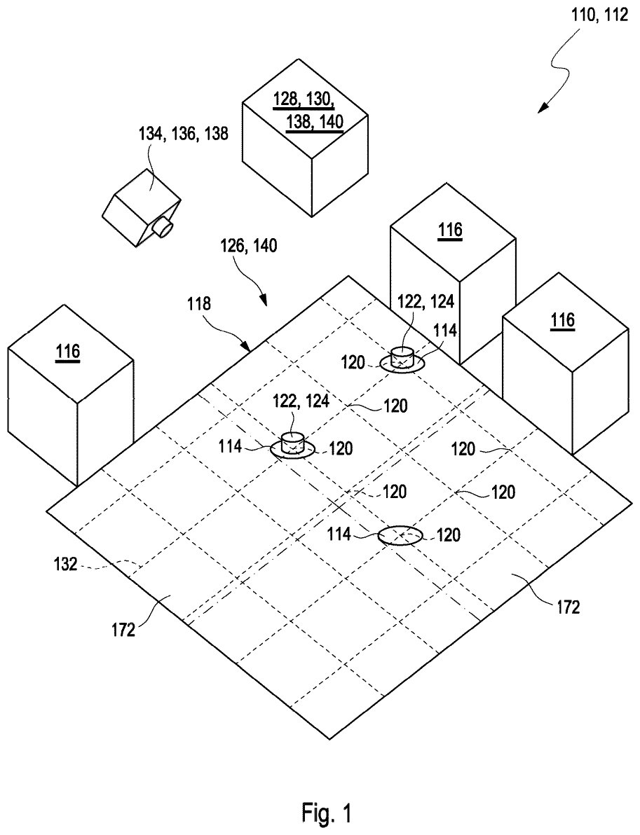

FIG. 1 shows an exemplary embodiment of a distribution system 110 in perspective view. The distribution system 110 may be an element of a laboratory automation system 112 allowing to distribute carriers 114 to a target destination within the laboratory automation system 112. Distribution systems 110 may be used in laboratory automation systems 112 comprising a number of laboratory stations 116, for example, pre-analytical, analytical and/or post-analytical stations.

The distribution system 110 comprises at least one transport plane 118 comprising logical positions 120 and a plurality of carriers 114 for transporting objects 122. In the example of FIG. 1, the object 122 may be or may comprise at least one sample container 124, such as laboratory diagnostic containers or vessels.

Further, the distribution system 110 comprises at least one drive system 126 for moving the carriers 114 on the transport plane 118 between the logical positions 120. The drive system 126 may be at least partially implemented in the carriers 114. For example, the carriers 114 may be passive carriers. For instance, a magnetic device may be fixed in the carrier 114 and a magnetic force provided by magnetically active and drivable elements, such as electro-magnetic coils (not shown in FIG. 1), enforce the carriers 114 to move by generated electro-magnetic fields. The coils can be installed under, above, besides or in the transport plane 118. For instance, an arrangement of magnetic coils underneath the transport plane 118 is described, e.g., in EP 2 566 787 or WO 2013/098202. In this example, the logical position 120 may be defined on the transport plane 118 as a position at which the carrier 114 can stop, start and/or change direction. In systems such as described in EP 2 566 787 or WO 2013/098202, the drive system 126 may define these logical positions 120 by its hardware limitations. Logical positions 120 may be defined above an electro-magnetic coil. At these positions 120, it may be possible to stop the carrier 114 and to change its direction with the next move.

The distribution system 110 further comprises at least one control system 128 configured for controlling the carriers 114 to move on a planned route from a start position to a final destination position on the transport plane 118. The planned route comprises partial routes. The control system 128 comprises at least one routing system 130 configured for calculating routing plans for carriers 114 on the transport plane 118 by modeling the transport plane 118 with graph of nodes 132. The routing system 130 is configured for calculating the routing plans considering moving time periods and waiting time periods. The routing system 130 is configured for assigning waiting time periods for carriers 114 depending on a reservation of logical positions 120 of the partial routes of other carriers 114. If a carrier 114 experiences a time delay during execution of a move, the routing system 130 is configured for shifting the experienced time delay to at least one upcoming waiting time period of a carrier 114.

As shown in FIG. 1, the distribution system 110 may further comprise an identification and registration system 134. In this example, the identification and registration systems 134 may be a camera system 136. However, other systems such as optical sensors and scanners identifying any optical signature on the carrier 114 or object 122, such as its size, its type, or a bar code, are also feasible. Alternatively or in addition, a RFID-reader system reading a unique RFID of the carrier 114 or object 122 on the carrier 114 or sensors inside the transport plane 118 can be used to identify logical positions 128 and to localize the carriers 114. A further option can be high precision GPS, in particular enhanced with Wi-Fi and/or GSM signals.

The distribution system 110 may comprise a position determination system 138 configured for determining positions of the carriers 114 on the transport plane 118. The position determination system 138 may send at least one position update message to the control system 128. The update message may trigger releasing of reserved logical positions 128 which were already passed by the carrier 114 on its current movement. The update message may inform the control system 128 about delayed carriers 114.

The control system 128 may comprise, besides the routing system 130, at least one executing unit 140 for execution of movements of the carriers 114 according to the planned routing plans. The control system 128 may control the drive system 126 to distribute carriers 114 from the initial position to the target destination. Specifically, controlling may comprise controlling the distribution of carriers 114 and, further, monitoring the distribution of carriers 114 and, if necessary, adapting or changing the distribution of carriers 114. The executing unit 140 may be configured for executing the planned routing plans for transporting the carriers 114 from their respective start position to their respective final position.

The calculating of the routing plans may comprise determining shortest paths for the carriers 114 across the transport plane 118 from the start position to the final destination position. The routing algorithm may be used for determining shortest paths for the carriers 114 across the transport plane 118. For example, a WHCA* search algorithm may be used for calculating the routing plans. With respect to WHCA* algorithm reference is made, e.g., to Silver, D., 2005, “Cooperative pathfinding,” Young, R. M., and Laird, J. E., eds., AIIDE, 117-122. AAA I Press. The WHCA* search algorithm may be an informed search algorithm such as A* or D* searching algorithm. For each carrier 114 with a final destination the search algorithm calculates a routing plan from the start position to an intermediate destination position on nodes within the cooperative search window of time length T towards their respective final destination position. The search is cooperative because the route can only pass on free time windows of logical positions 120. For the logical positions 120 with free time windows needed the required duration of the free time window will change from “free” to “reserved” for the required time slot of the respective logical positions 120. So the free time window will be split into a reserved time window and one or two further free time windows. The search is hence cooperative for the cooperative time window T by respecting the reserved time windows for other carriers 114 of the logical positions 120. The WHCA* algorithm may be designed for planning a route for each carrier 114 individually, wherein cooperation may be obtained using a reservation table. The routing system 130 may be configured for reserving the planned partial route for the carrier 114 until the carriers 114 reaches its intermediate or final destination. This means that no other carrier 114 can use the reserved route while the respective carrier 114 is moving. If the logical position 120 is set to “reserved” for a finite duration, the position 120 is not available for the other carriers 114 during the finite duration and will be available again for a move once the temporary reservation is over.

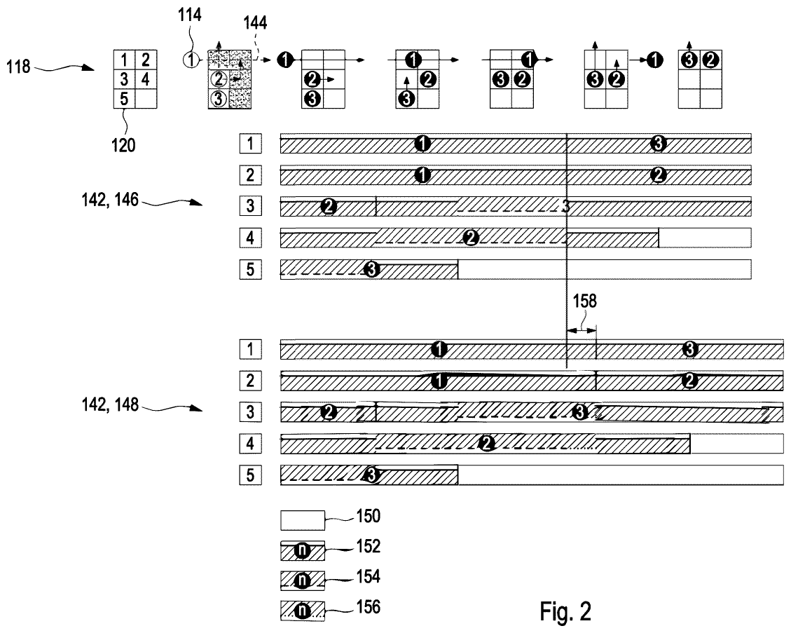

An example of a routing plan 142 is shown in FIG. 2. Specifically, in the example of FIG. 2, a transport plane 118 comprising logical positions 120 no. 1 to 5 and carriers 114 no. 1 to 3, illustrated in FIG. 2 by filled circles, moving on the transport plane 118 via partial routes 144 are shown together with an original routing plan 146 and a new routing plan 148 for the logical positions 120 no. 1 to 5. The routing plan 142 may comprise for each logical position 120 a free time window 150, a reserved time window, specifically a reserved time window 152 being reserved for moving carrier 114 no. n, n=1, 2, . . . 5, and a reserved time window being 154 reserved for waiting carrier 114 no. n, and/or an increased reservation time window 156 for waiting carrier 114 no. n. As can be seen from the partial routes 144 shown on the transport plane 118 and from the original routing plan 146, carriers 114 no. 2 and 3 may have to wait with their partial routes 144 until carrier 114 no. 1 has completed the corresponding partial route 144 over logical positions 120 no. 1 and 2. If carrier 114 no. 1 experiences a time delay 158 during execution of the move over logical positions 120 no. 1 and 2, logical positions 120 no. 1 and 2 may have to be reserved for carrier 114 no. 1 for a longer duration of time in the new routing plan 146. Consequently, logical positions 120 no. 3 and 4 may have to be reserved for a longer duration of time for carriers 114 no. 2 and 3, respectively.

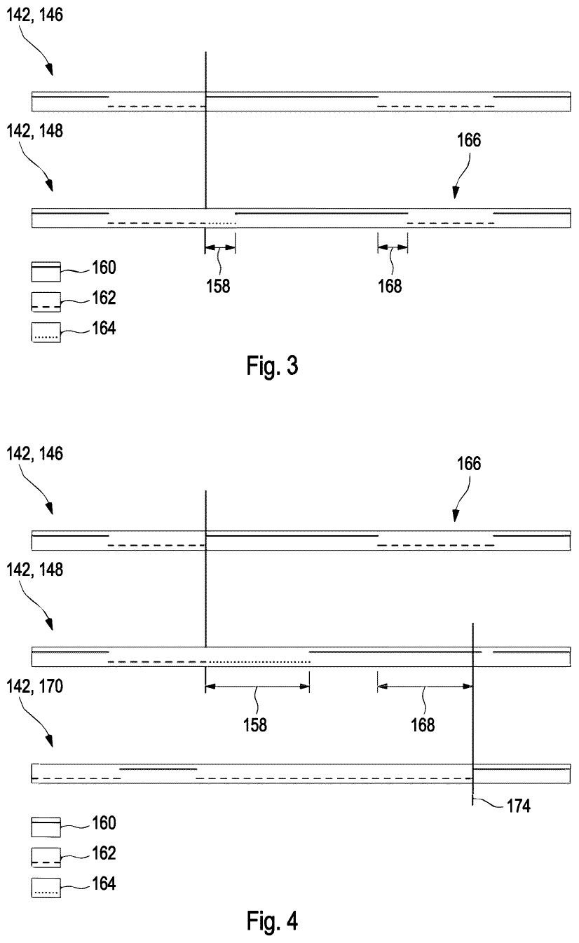

The reservation for the late carrier 114 no. 1 may need to be adapted, specifically extended. However, in known approaches the extension of the reservation for the late carrier 114 no. 1 would influence and/or cross the reservations for other carriers 114. The present disclosure proposes that the routing system 130 is configured for extending the reservation for the late carrier 114 no. 1 without shifting or recalculating all plans 142, e.g., specifically without shifting or recalculating plans 142 of carriers 114 that are not affected. The present disclosure proposes resolving the delay 158 by using waiting times to compensate for the lost times. If the carrier 114 no. 1 experiences the time delay 158 during a move, the routing system 130 is configured for shifting the experienced time delay 158 to at least one upcoming waiting time period of a carrier 114, e.g., of the delayed carrier 114 no. 1. This is illustrated in FIG. 3. Specifically, FIG. 3 shows the original routing plan 146 and the new routing plan 148 for the delayed carrier 114 no. 1 of FIG. 2. The routing plan 142 for the carrier 114 may comprise a moving time period 160, a waiting time period 162 and/or an increased waiting time period 164, specifically a waiting time period which was increased due to a time delay 158.

As outlined above, the routing system 130 is configured for shifting the experienced time delay 158 to the at least one upcoming waiting time period 166 of a carrier 114, e.g., of the delayed carrier 114. The routing system 130 may be configured for compensating the time delay 158 by shortening the at least one upcoming waiting time period 166 of a carrier 114, e.g., of the delayed carrier 114, depending on the time delay 158. As can be seen in FIG. 3, the upcoming waiting time period 166 may be at least one waiting time period 162 subsequent to the delay 158. The routing system 130 may be configured for compensating the time delay 158 by shortening the next, also denoted as first, upcoming waiting time period 166 of the delayed carrier 114, e.g., by the amount of the time delay 158 (denoted by reference number 168). However, if the time delay 158 is longer than the upcoming waiting time period 166, the time delay 158 cannot be fully compensated by said upcoming waiting time period 166. Thus, the routing system 130 may be configured for compensating the time delay 158 at least partially by shortening the upcoming waiting time period 166. In case of a residual time delay, i.e., if the time delay 158 cannot be fully compensated by a first upcoming waiting time period 166, the routing system 130 may be configured for at least partially shifting the time delay to at least second upcoming waiting time period, e.g., of at least one affected carrier. The routing system 130 may be configured 158 for shifting a non-compensated part of the time delay 158 to the at least one second upcoming waiting time period. The first upcoming waiting time period 166 may be followed in time by the second upcoming waiting time period. If the time delay 158 still cannot be fully compensated by the next waiting time of a carrier 114, its subsequent waiting time may be used to compensate for the remaining delay, and so on until the delay 158 is completely resolved.

In this example, one carrier 114 of a plurality of carriers 114 may be delayed in time. Thus, the original plan 146 is failed. The delay 158 may occur at a first moving time period 160. The routing system 130 may be configured for compensating the time delay 158 by shortening the upcoming waiting time period 166. In most cases where only occasionally a short delay 158 occurs, as illustrated in FIG. 3, the upcoming waiting time period 166 may already be long enough to be used for compensation. Hence, a solution can be quickly found without affecting many carriers 114 and without computation-intensive re-planning. If the time delay 158 cannot be fully compensated for the upcoming waiting time period 166, e.g., in case the upcoming waiting time period 166 is too short, all waiting time of the upcoming waiting time period 166 may be consumed and the subsequent upcoming waiting time period may be used partially or completely as well, and so on. Hence, the method is recursively executed into the planning future until all delays 158 have been compensated for.

FIG. 4 shows another example of routing plan 142. Specifically, FIG. 4 shows an original routing plan 146 for a first carrier 114, a new routing plan 148 for said first carrier 114 and a routing plan 170 of a second carrier 114. The first carrier 114 may be delayed and, thus, may experience a time delay 158. The second carrier 114 may be an additional carrier 114 without time delay 158.

In the distribution system 110, a maximal number of simultaneous moves may be fixed for the whole transport plane 118 or be defined per area. The moves allowed to be performed simultaneously may form a so-called simultaneous moves group. For example, maximum eight carriers 114 may be allowed to move simultaneously per transport module 172 or software-defined area. The transport module 172 may be a separated constructional unit and/or sub-unit of the transport plane 118 comprising at least one logical position 120, as indicated in FIG. 1 by the dotted lines. In this example, the transport modules 172 comprise a plurality of logical positions 120. The number of maximum allowed simultaneous moves can also be related to the number of logical positions 120 in that area. For instance, the maximum allowed simultaneous moves in an area, e.g., can be in the range of 1% to 70% or 5% to 50% or 10% to 30% or 15% to 25% of the number of available logical positions 120 in the area. This may limit the maximum power draw peaks for that area, such that less or smaller power supplies can be used or to protect electronic circuitry against fast aging or damage.

As can be seen in FIG. 4, by using the at least one upcoming waiting time period 166 for compensating for the time delay 158 of the first carrier 114, a problem might happen that the maximum simultaneous moves constraint is violated as plans are shifted out of the original time window of the original simultaneous moves group. In this example, the first and the second carrier 114 may violate the maximum simultaneous moves constraint (denoted by reference number 174). The original simultaneous moves group may comprise the moves originally planned to be performed simultaneously, i.e., according to the original plans 146 of the routing system 130 without delays 158. Thus, in case only a maximum number of simultaneous moves is allowed, this rule may be violated if no measures are taken. The routing system 130 may be configured for adapting originally planned move times of the carriers 114 that would violate the constraint of maximal number of simultaneous moves. The plans 142, 170 for the affected additional carriers 114, that would violate the maximum simultaneous moves constraint, in this example the routing plan 170 of the second carrier 114, may be shifted as well and similar to the plans 148 of the delayed carriers 114. Their waiting times may be used to try to compensate for the delays 158.

FIG. 5 shows a flow chart of an embodiment of a method for distributing a plurality of carriers 114 using the distribution system 110 according to the present disclosure is disclosed. The method comprises using the distribution system 110 as described above, such as according to the embodiment described in FIG. 1 and/or according to any embodiment given in further detail below. The method may comprise the following steps, which may be performed in the given order or may be performed in a different order. Further, one or more additional method steps may be present which are not listed. Further, one, more than one or even all of the method steps may be performed repeatedly.

The method comprises moving the plurality of carriers 114 on the at least one transport plane 118 of the distribution system 110 between the logical positions 120 by using the at least one drive system 126 (denoted by reference number 176). The method comprises controlling the carriers 114 to move on a planned route from the start position to the final destination position on the transport plane 118 by using the control system 128 (denoted by reference number 178). The planned route comprises partial routes 144. The method comprises calculating routing plans for carriers 114 on the transport plane 118 by modeling the transport plane 118 with graphs of nodes 132 by using the routing system 130 (denoted by reference number 180). The calculated routing plans comprise moving time periods 160 and waiting time periods 162. The calculating comprises assigning waiting time periods 162 for carriers 114 depending on a reservation of logical positions 120 of the partial routes 140 of other carriers 114 (denoted by reference number 182). The calculating comprises, if a carrier 114 experiences a time delay 158 during execution of a move, shifting the experienced time delay 158 to at least one upcoming waiting time period 166 of the delayed carrier 114 (denoted by reference number 184).

The method may comprise compensating the time delay 158 at least partially by shortening the at least one upcoming waiting time period 166 of the delayed carrier 114 depending on the time delay 158 (denoted by reference number 186). In case of a residual time delay, the method may comprise at least partially shifting the residual time delay to at least one second upcoming waiting time period (denoted by reference number 188), e.g., of at least one affected carrier. The first upcoming waiting time period may be followed in time by the second upcoming waiting time period.

The method may comprise calculating routing plans, in particular move times, considering a constraint of a maximal number of simultaneous moves per transport plane 118 or per area of the transport plane 118 (denoted by reference number 190), wherein the moves allowed to be performed simultaneously form a simultaneous moves group. The total transport surface may be divided into one or multiple areas and an allowed maximum number of simultaneous moves may be different per area The plans of original routes of the carriers 114 that would violate the constraint of maximal number of simultaneous moves may be adapted.

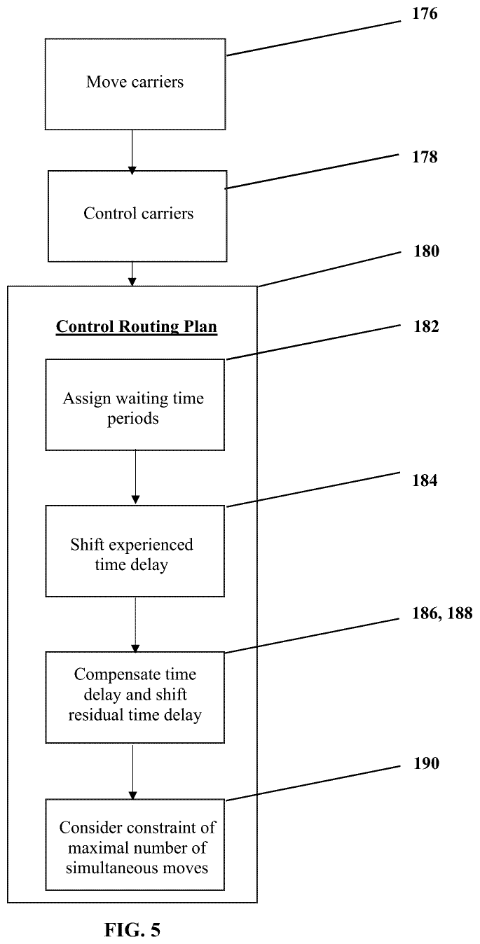

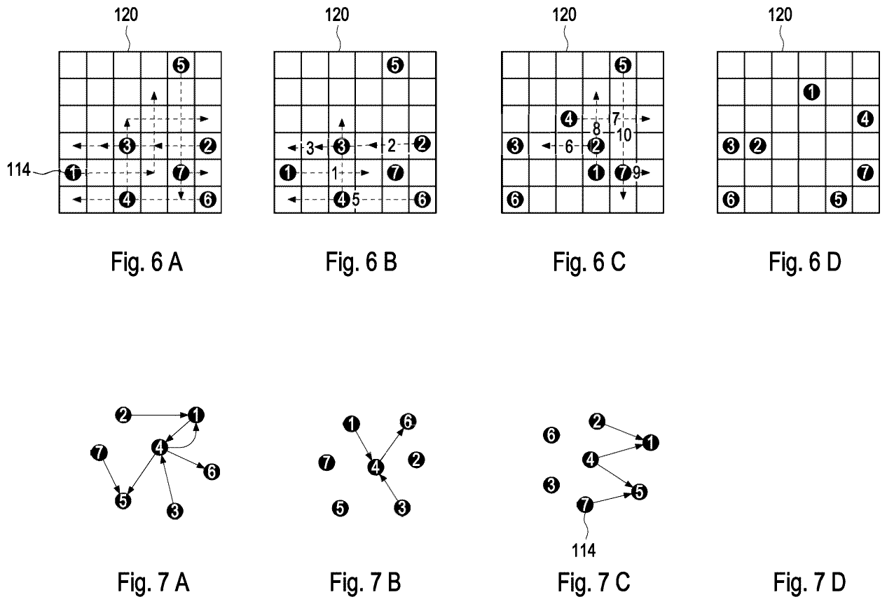

FIGS. 6A to 6D and 7A to 7D show dependency of plans of carriers 114, consequences of delays and resolving these. The number in the circles represent the carriers i, with i running from 1 to 7 in this example.

FIG. 6A shows an example of a partial plan of planned moves. It shows all the moves to be made during the whole partial plan. The carriers 114 may start moving at different times and reserving fields that will also be used for other moves. Because of this, dependencies may exist between the time plans of some of the moves of carriers 114.

FIGS. 6B to 6D show some of the moves made during certain time periods of the partial plan. The order in which the moves are planned in time are shown by the number of the arrows. A move with a lower number is carried out before a move with a higher number.

FIG. 7B shows that if carrier 4 wants to move, it can only do so after carrier 1 has passed and released the reservation of the required positions. Likewise with carrier 3. Hence, there is a dependency of the plan of carrier 4 on the plans of carrier 1 and 3. The move plan of carrier 6 depends on carrier 4 and therefore indirectly on 1 and 3 etc. Not all carriers may be planned to move yet, so at this early time, carriers 5 and 7 have no arrows yet. Also at this time, some carriers' moves may not have a dependency (yet), like 5 and 7. The dependencies can be indicated by the directed graphs in FIGS. 7A to 7C. For this first phase, see FIG. 6B, the occurred dependencies are shown by FIG. 7B. An arrow from carrier 1 to carrier 4 indicates that the plan of carrier 4 depends on the plan of carrier 1.

FIG. 6C shows a later moment in time where new moves, see FIG. 6C, and therefore also dependencies, see FIG. 7C occur. If summing up all dependencies occurring during the full partial plan, the graph as shown in FIG. 7A is obtained. Here it can be observed that the dependency arrows between carriers can be in both directions. Examples are carriers 1 and 4. Initially the move of carrier 4 depends on the move of carrier 1, but later on, it is the other way around. FIG. 6D shows the end result of all moves.

If the execution of a planned move of a carrier 114 is delayed, this delay may be resolved by using a planned waiting time of a carrier 114. For example, if carrier 1 is delayed, the waiting time of this carrier is used. If the waiting time is too short to completely resolve the delay, the plans of the affected, thus dependent carriers, may be shifted and their waiting times may be used. In this case carrier 4. If this would not affect the plan of carrier 6 the problem is solved, otherwise also carrier 6 has to delay and so on. These time shifts will not affect non-dependent carriers.

If the initial delay and its causing delays cannot be fully solved by the first moves, the remaining delays may be pushed to the subsequent moves. This may allow solving the delay here and so on. As seen in the dependency graphs (FIG. 7B versus 7A), the deeper in time the method has to find ways for using waiting times to resolve the delay of carrier 1, the more carriers may be involved to donate their waiting times partially or completely.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE NUMBERS

110 distribution system
112 laboratory automation system
114 carrier
116 laboratory station
118 transport plane
120 logical position
122 object
124 sample container
126 drive system
128 control system
130 routing system
132 graph of nodes
134 identification and registration system
136 camera system
138 position determination system
140 executing unit
142 routing plan
144 partial routes
146 original routing plan
148 new routing plan
150 free time window
152 reserved time window being reserved for moving carrier no. n
154 reserved time window being reserved for waiting carriers no. n
156 increased reservation time window for waiting carrier no. n
158 time delay
160 moving time period
162 waiting time period
164 increased waiting time period
166 upcoming waiting time period
168 shortening the upcoming waiting time period
170 routing plan of a second carrier
172 transport module
174 violation of the maximum simultaneous moves constraint
176 moving the plurality of carriers
178 controlling the carriers
180 calculating a routing plan
182 assigning waiting time periods
184 shifting the experienced time delay
186 compensating the time delay
188 shifting the residual time delay
190 considering a constraint of a maximal number of simultaneous moves

What is claimed is:

1. A distribution system, comprising:
a transport plane comprising logical positions;
a plurality of carriers for transporting objects;
a drive system for moving the carriers on the transport plane between the logical positions; and
a control system configured for controlling the carriers to move on a planned route from a start position to a final destination position on the transport plane, wherein the planned route comprises partial routes, wherein the control system comprises a routing system configured for calculating routing plans for carriers on the transport plane by modeling the transport plane with graphs of nodes, wherein the routing system is configured for calculating the routing plans considering moving time periods and waiting time periods, wherein the routing system is configured for assigning waiting time periods for carriers depending on a reservation of logical positions of the partial routes of other carriers, wherein, if a carrier experiences a time delay during execution of a move, the routing system is configured for shifting the experienced time delay to at least one upcoming waiting time period of a carrier.

2. The distribution system according to claim 1, wherein the routing system is configured for determining if the delay of the carrier affects at least one further carrier, wherein the routing system is configured for shifting the time delay to at least one waiting time of the at least one further affected carrier.

3. The distribution system according to claim 1, wherein the routing system is configured for recursively resolving the routing plans of carriers which are directly and/or indirectly affected by the delay of the carrier.

4. The distribution system according to claim 1, wherein the routing system is configured for compensating the time delay at least partially by shortening the at least one upcoming waiting time period of a carrier depending on the time delay.

5. The distribution system according to claim 4, wherein, in case of a residual time delay, the routing system is configured for at least partially shifting the residual time delay to second upcoming waiting time period.

6. The distribution system according to claim 5, wherein the first upcoming waiting time period is followed in time by the second upcoming waiting time period.

7. The distribution system according to claim 1, wherein the routing system is configured for calculating routing plans considering a constraint of a maximal number of simultaneous moves per transport plane or per area of the transport plane, wherein the moves allowed to be performed simultaneously form a simultaneous moves group, wherein the total transport surface is divided into one or multiple areas and an allowed maximum number of simultaneous moves is different per area.

8. The distribution system according to claim 7, wherein the routing system is configured for adapting originally planned routing plans of the carriers that would violate the constraint of maximal number of simultaneous moves.

9. The distribution system according to claim 1, wherein the control system comprises at least one executing unit configured for executing the routing plans for transporting the carriers from their respective start position to their respective final position.

10. The distribution system according to claim 1, the routing system is configured for using a cooperative path finding algorithm for calculating the routing plans, specifically a Windowed Hierarchical Cooperative A*-algorithm (WHCA*).

11. A method for distributing a plurality of carriers using a distribution system according to claim 1, wherein the method comprises moving the plurality of carriers on the transport plane of the distribution system between the logical positions by using the drive system, wherein the method comprises controlling the carriers to move on a planned route from the start position to the final destination position on the transport plane by using the control system, wherein the planned route comprises partial routes, wherein the method comprises calculating routing plans for carriers on the transport plane by modeling the transport plane with graphs of nodes by using the routing system, wherein the calculated routing plans comprise moving time periods and waiting time periods, wherein the calculating comprises assigning waiting time periods for carriers depending on a reservation of logical positions of the partial routes of other carriers, wherein the calculating comprises, if a carrier experiences a time delay during execution of a move, shifting the experienced time delay to at least one upcoming waiting time period of a carrier.

12. The method according to claim 11, wherein the method further comprises determining if the delay of the carrier affects at least one further carrier and shifting the time delay to at least one waiting time of the at least one further affected carrier.

13. The method according to claim 11, wherein the method further comprises recursively resolving the routing plans of carriers which are directly and/or indirectly affected by the delay of the carrier.

14. The method according to claim 11, wherein the method comprises compensating the time delay at least partially by shortening the at least one upcoming waiting time period of a carrier depending on the time delay.

15. The method according to claim 14, wherein, in case of a residual time delay, the method comprises at least partially shifting the residual time delay to at least one second upcoming waiting time period, wherein the first upcoming waiting time period is followed in time by the second upcoming waiting time period.
